(19) United States
(12) Patent Application Publication
(10) Pub. No.: US 2011/0104338 A1
(43) Pub. Date: May 5, 2011

(54) Food Product Pertaining To A Filling-And-Cracker Sandwich

(76) Inventors: Edward C. Coleman, New Fairfield, CT (US); Priyank Tulsiyan, Bakersfield, CA (US)

(21) Appl. No.: 12/913,513

(22) Filed: Oct. 27, 2010

Related U.S. Application Data
(60) Provisional application No. 61/256,850, filed on Oct. 30, 2009.
(60) Provisional application No. 61/338,314, filed on Feb. 16, 2010.

(51) Int. Cl. A23L 1/314; A23L 1/317; C11B 5/00

(52) U.S. Cl. 426/92; 426/541; 426/274

(57) ABSTRACT

A single serving of a food product can comprise a first cracker, a second cracker, and a non-cracker filling disposed between these crackers to form a cracker-and-filling sandwich. By one approach, the cracker-and-filling sandwich is sized and comprised of ingredients such that eating the cracker-and-filling sandwich as a between-meal snack satisfactorily sates an average adult human being's appetite. By one approach, these crackers have savory shelf-stable filling. By another approach, the savory shelf-stable filling includes a particulate component, such as a particulate meat component. By this approach, the shelf-stable savory filling has a low water activity and covers at least 50 percent of the surface area of the meat particles.

### CROSS-REFERENCE TO RELATED APPLICATIONS

This application claims the benefit of U.S. Provisional Application No. 61/256,850, filed Oct. 30, 2009, and U.S. Provisional Application No. 61/338,314, filed Feb. 16, 2010, which are hereby incorporated herein by reference in their entireties.

### TECHNICAL FIELD

This invention relates generally to food products and in some embodiments to pre-packaged snack items.

### BACKGROUND

Food products of various kinds are known in the art. This includes an entire genre of items popularly referred to as snack items. Snack items are food products that are typically intended and designed for consumption between normally-scheduled meals (these being breakfast, lunch, and dinner, respectively). Generally speaking, and as used herein, a “snack” is something that is intended to assuage a person's hunger pending that next normally-scheduled meal. The degree to which a given food product succeeds in this regard is a measure of that food product's satiety.

Crackers of various kinds are often treated, alone or in combination with other ingredients, as a snack. Cheese or cheese-like fillings are often used in combination with two crackers that form a small corresponding sandwich. A packaged offering in these regards will typically include a plurality of such sandwiches. The total contents of such a packaged offering may comprise, in the aggregate, an intended single serving as a snack or may contain multiple servings.

Packaged snack foods are highly popular in many cultures. Confusion can arise on the part of the consumer, however, regarding appropriate snack portions and serving sizes. This confusion can lead to both under and over-consumption. Under-consumption can, in turn, lead to re-experienced hunger prior to the next naturally-scheduled meal, while over-consumption has its own associated plethora of unwanted consequences.

### BRIEF DESCRIPTION OF THE DRAWINGS

The above needs are at least partially met through provision of the a food product pertaining to a filling-and-cracker sandwich described in the following detailed description, particularly when studied in conjunction with the drawings, wherein:

FIG. 1 comprises a flow diagram as configured in accordance with various embodiments of the invention;

FIG. 2 comprises a perspective view as configured in accordance with various embodiments of the invention;

FIG. 3 comprises a top plan detail view as configured in accordance with various embodiments of the invention;

FIG. 4 comprises an exploded perspective view as configured in accordance with various embodiments of the invention;

FIG. 5 comprises an exploded perspective view as configured in accordance with various embodiments of the invention.

FIG. 6 comprises a top plan view as configured in accordance with various embodiments of the invention;

FIG. 7 comprises a perspective detail view as configured in accordance with various embodiments of the invention;

FIG. 8 comprises a perspective view as configured in accordance with various embodiments of the invention;

FIG. 9 comprises a perspective view as configured in accordance with various embodiments of the invention;

FIG. 10 comprises a perspective view as configured in accordance with various embodiments of the invention;

FIG. 11 comprises an exploded perspective view as configured in accordance with various embodiments of the invention;

FIG. 12 comprises a top plan view as configured in accordance with various embodiments of the invention;

FIG. 13 comprises a perspective view as configured in accordance with various embodiments of the invention; and

FIG. 14 comprises a histogram.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a single serving of a food product can comprise a first cracker, a second cracker, and a non-cracker filling disposed between the first and second crackers to form a corresponding cracker-and-filling sandwich. By one approach, the cracker-and-filling sandwich is sized and comprised of ingredients such that eating the cracker-and-filling sandwich as a between-meal snack satisfactorily sates an average adult human being's appetite pending a next normally-scheduled meal. By one approach, the aforementioned filling has an adhesive characteristic sufficient to retain first and second crackers in place during pre-sale handling, distribution, and sale of the food product, but wherein the adhesive characteristic is not sufficient to prevent an end user from easily removing, by use of an average adult human's hands only, one of the crackers from the filling without breaking either of the crackers and without requiring that the cracker being removed be rotated with respect to the filling.

The cracker-and-filling sandwich product described herein in certain embodiments is a shelf-stable product having a savory filling. In one aspect, the filling may be a savory filing having a smooth, creamy texture. Advantageously, the filling remains smooth and creamy and the crackers maintain their crisp texture characteristic of crackers during the shelf-life of the food product, preferably at least four months at ambient temperatures. In another aspect, the savory filling may include a particulate component, preferably a particulate meat component. The cracker product including the particulate meat component in the filling is also shelf-stable at ambient temperatures for at least about four months. Shelf-life of the products can be further increased by storage at refrigeration temperatures, if desired.

This single-serving food item can be individually wrapped as a single-serving package. Supplemental food ingredients can accompany such a package. By one approach, one of the crackers can be easily removed from the cracker-and-filling sandwich to expose the filling and the supplemental food ingredient(s) placed thereon. The removed cracker can then be replaced to yield a nutritionally-supplemented cracker-and-filling sandwich.

Though cracker-and-filling sandwiches are known in the art, the cracker-and-filling sandwich described herein has numerous unique characteristics and properties. The ease by which the sandwich can be partially disassembled in at least some embodiments permits additional ingredients to be easily added. This permits a nutritional amplification that leverages the cracker-and-filling sandwich into a valid meal component. The size, shape, and constituent components of the cracker-and-filling sandwich, in turn, yield a single cracker-and-filling sandwich with the surprising ability to sate an ordinary between-meals appetite. The cracker-and-filling sandwich comprising a particulate meat component in the filling can provide additional ability to sate a consumer's appetite between meals.

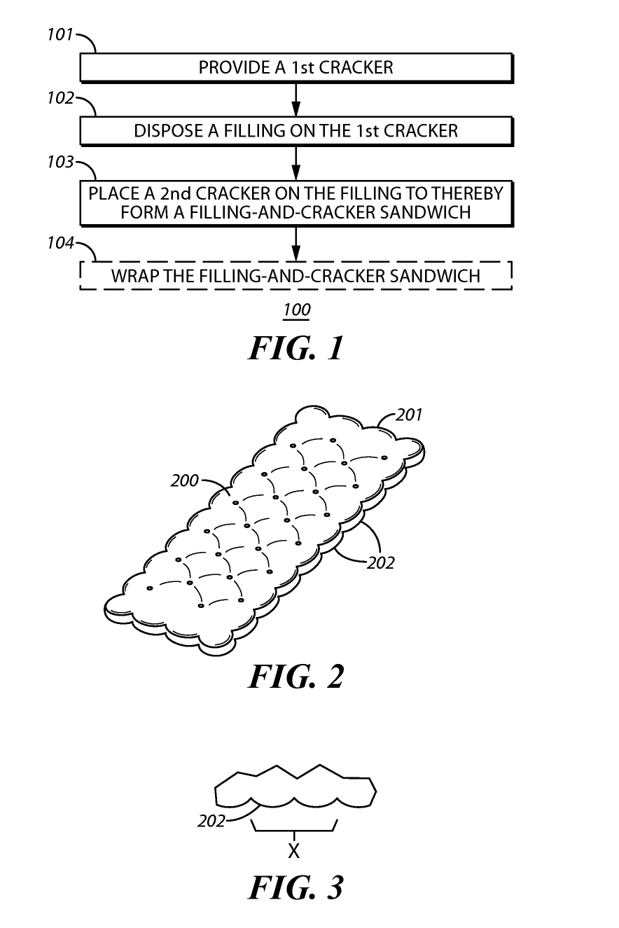

These and other benefits may become clearer upon making a thorough review and study of the following detailed description. Referring now to the drawings, and in particular to FIG. 1, an illustrative process 100 that is compatible with many of these teachings will now be presented.

Pursuant to step 101, this process 100 provides a first cracker. Those skilled in the art will understand a cracker to be a dry, thin, crispy, baked biscuit. As a non-limiting illustrative example in these regards, and referring momentarily to FIG. 2, this first cracker 200 can be relatively large (having a length, for example, of about 4.5 inches and a width of at least about 1 inch, such as at least about 1.5 inches). Other dimensions can also be used, if desired.

By one approach, and as illustrated, the periphery 201 of this first cracker 200 can comprise a plurality of scallops 202. Somewhat in accord with the relatively large size of the first cracker 200 itself, these scallops 202 are themselves rather large. As one illustrative example in these regards, and referring now momentarily to FIG. 3, there can be, on average, about two such scallops 202 per X where “X” is a distance ranging from, for example, about 0.5 to about 2 inches. In this particular illustrative example, and again without intending any particular limitations in these regards, X is about 1 inch, but other dimensions can also be used if desired.

This first cracker 200 can be formed using any of a variety of ingredients as will be well understood by those skilled in the art. By one approach, and in this illustrative example, this first cracker 200 will be at least substantially similar to the well-known Ritz brand cracker as baked and offered by Nabisco (albeit possibly somewhat thicker; here, this first cracker can have an average thickness of about 0.2 inches). Other thicknesses can also be used depending on the particular taste and structural attributes desired of the final product.

The cracker formulation for the cracker-and-filling sandwich is designed to provide good organoleptic properties and shelf-stability while maintaining a crisp but savory mouthfeel. The crackers do not become soggy due to moisture migration from the filling or oil-soaked due to release of oil from the filling even without the use of a moisture barrier on the surface of the filling or cracker, although a moisture barrier may be used if desired.

The crackers can be prepared according to the illustrative formulation in Table 1 below:

TABLE 1

| | Range | Preferred Range |
|---|---|---|
| Ingredient | (% wt.) | (% wt.) |
| Oil | 2-20% | 4-8% |
| Emulsifier | 0-1% | 0-1% |
| Sweetener | 0-20% | 0-8% |
| Flour | 50-75% | 55-70% |
| Water | 10-35% | 10-25% |
| Leavening agent | 0-5% | 0-5% |
| Enzymes | 0-3% | 0-3% |

Exemplary of the flour component which may be used, for example, are whole grain or refined wheat flour. Hard or soft wheat flours, red or white wheat flours, winter or spring, and blends thereof, all purpose flours, graham flour, and so forth may be used. The flour may be bleached or unbleached. Wheat flour or mixtures of wheat flour with other grains may be used.

Exemplary oils include vegetable oils, shortening, hydrogenated oil, and the like. Preferred vegetable oils are palm, corn, canola, sunflower seed, cottonseed and soybean oils, or mixtures thereof, with soybean oil and corn oil being the most preferred. The oil may have a flavoring agent, if desired, such as a butter flavoring agent. Alternatively, if desired, a butter flavoring agent or other flavoring agent may be added to the recipe in an amount known to those skilled in the art or in accordance with the flavor manufacturer's recommendations. The oils may also be provided with preservatives, if desired. Fat substitutes may also be used, if desired.

Exemplary leavening agents include yeast (e.g., dried yeast, compressed yeast), chemical leavening agent (e.g., sodium bicarbonate, ammonium bicarbonate, calcium bicarbonate), leavening acid (e.g., sodium aluminum phosphate, monocalcium phosphate anhydrous or monohydrate, sodium acid pyrophosphate, sodium aluminum sulfate, monopotassium tartrate, dicalcium phosphate dihydrate, glucono-delta-lactone, calcium phosphate monobasic), mixtures thereof, and the like. Other organics acids suitable for baking may also be used, such as fumaric acid, lactic acid, tartaric acid, malic acid, citric acid, and the like. Preferably, a combination of chemical leavening agent and leavening acid is used, such as a combination of sodium bicarbonate, ammonium bicarbonate, calcium phosphate monobasic, or mixtures thereof is used.

The cracker dough may also include sweeteners. These include sugars such as sucrose, fructose, glucose, high fructose corn syrup, or other sweet mono- or disaccharides commonly used in baking materials. All or a portion of the sugars may be augmented with artificial sweetener, non-nutritive sweetener, high intensity sweetener, sugar alcohol materials, and the like.

Emulsifiers are included in effective, emulsifying amounts in the dough of the disclosure. Exemplary emulsifiers which may be used include, but are not limited to, mono- and di-glycerides, polyoxyethylene sorbitan fatty acid esters, DATEM (di-acetyl tartaric acid esters of mono- and diglycerides), lecithin, stearoyl lactylates, and mixtures thereof. Exemplary of the polyoxyethylene sorbitan fatty acid esters which may be used are water-soluble polysorbates such as polyoxyethylene (20) sorbitan monostearate (polysorbate 60), polyoxyethylene (20) sorbitan monooleate (polysorbate 80), and mixtures thereof. Examples of natural lecithins which may be used include those derived from plants such as soybean, rapeseed, sunflower, or corn, and those derived from animal sources such as egg yolk. Soybean-oil-derived lecithins are preferred. Exemplary of the stearoyl lactylates are alkali and alkaline-earth stearoyl lactylates such as sodium stearoyl lactylate, calcium stearoyl lactylate, and mixtures thereof

The cracker dough also may contain minor amounts of other functional and flavoring additives commonly used in cracker dough, such as enzymes, preservatives, salt, dough conditioners, herbs, seasonings, spices, and the like, if desired. The cracker dough may also be fortified with macronutrients and/or micronutrients, such as iron preparations, bioavailable calcium sources, vitamins, minerals, amino acids, and other nutraceuticals.

The cracker dough ingredients may be combined all at once or in separate stages. The particular order of addition of the ingredients is not critical and may depend on the particular equipment available. The cracker dough formulation can be formed into crackers using a variety of techniques. For example, the dough is mixed, proofed (e.g., for about 30 minutes to about 240 minutes), and shaped, such as by using a cutter. A cutter can serve to unitize individual crackers having the desired shape, size and weight. Topping salt can also be added at this time. The length of time and temperature selected for baking will generally depend on the type of oven available. Generally, the dough can be baked in a conventional oven at a temperature of about 250 to about 550° F. for about 3 to about 10 minutes to provide the desired bake profile, although other temperatures and bake times may also be used so long as the desired bake profile is provided.

Referring again to FIG. 1, this process 100, at step 102, provides for disposing a filling on the first cracker 200. This filling can comprise a relatively viscous yet somewhat flowable material that will tend to retain its shape but which is also readily malleable. Though any number of ingredients can serve as a primary or secondary component of this filling, cheese is a particularly useful choice. Accordingly, for the purposes of illustration (but again without intending any limitations in these regards) this filling will be presented in this description as comprising a cheese-based filling.

In one aspect, the aforementioned filling can comprise a cheese-based filling. The cheese in the cheese-based filling can be a natural or artificial cheese. Preferably, the cheese-based filling comprises cheese powder.

An exemplary recipe for the filling is provided in Table 2 below:

TABLE 2

| Ingredient | Range | Preferred Range |
|---|---|---|
| Fat component | 25-50% | 30-40% |
| Emulsifier | 0-2% | 0.01-1% |
| Bulking agent | 10-50% | 25-35% |
| Cheese powder | 20-45% | 25-35% |
| Flavorings | 0-2% | 0.5-1% |
| Moisture | 0-20% | 0-10% |

Exemplary fat components comprise oils and/or fats, such as vegetable oils, shortening, hydrogenated fats or oils, and the like. The preferred vegetable oils are palm, soybean, canola, cottonseed, sunflower, or mixtures thereof. Fat substitutes such as Olestra™ and Benefat™ can also be used in combinations with such oils or fats. The oil or fat may also include a flavoring agent, if desired.

The emulsifier may be any convention emulsifier, including, but not limited to, lecithin, mono- and di-glycerides, polyoxyethylene sorbitan fatty acid esters, DATEM (di-acetyl tartaric acid esters of mono- and diglycerides), stearoyl lactylates, and combinations thereof

The bulking agent preferably includes one or more compounds which act as a fat mimetic. As used herein, the term “bulking agent” includes carbohydrates and derivatives thereof, such as polysaccharides, fiber, sugar, starch, and derivatives thereof, which contribute to the textural qualities (e.g., lubricity, smoothness, mouthfeel, firmness) of the filling. For example, exemplary bulking agents include corn syrup solids, soluble fiber, inulin, maltodextrin, resistant maltodextrin, lactose, and combinations thereof. In particular, resistant maltodextrin was found to contribute to the smooth mouthfeel and texture of the filling. A particularly preferred bulking agent comprises about 10 to about 20% resistant maltodextrin, about 5 to about 15% maltodextrin, and about 5 to about 15% corn syrup solids.

The cheese powder may be any prepared from any cheese type, including, for example, process cheese, natural or artificial cheese. Exemplary cheese powders include commercially available cheese powders prepared from natural or process cheeses. Such cheese powders generally have a low moisture content (generally less than about 3 percent). The cheese powder may be any flavor cheese, such as cheddar cheese, Swiss cheese, American cheese, provolone cheese, mozzarella cheese, Parmesan cheese, blue cheese, Monterey Jack cheese, Romano cheese, cream cheese, Havarti cheese, Gouda cheese, Muenster cheese, Asiago cheese, Gorgonzola cheese, or a combination thereof. In one aspect, the cheese powder has a water activity of less than about 0.4. In another aspect, the cheese powder has a water activity of less than about 0.3. Commercially-available cheese powders which can be used herein include, for but are not limited to, Cheeztang NCS, Chedasharp 501 Uncolored, Sequoia II Colored, MozzarellaZing, ParmZing, Sequoia 2 Uncolored, Cream Cheeztang, and combinations thereof, which are sold by Kraft Food Ingredients. The particular flavor or combinations or flavors can be selected to provide the desired flavor profile to the filling.

As the fat component and cheese powder ingredients described above each contain fat, the precise amounts of cheese powders, bulking agent, and fat component can be adjusted to provide the desired total amount of fat in the final product. It has been found that preferred fillings have a total fat content of about 30 to about 65 percent, more preferably about 40 to about 55 percent.

The filling may also contain other ingredients so long as they do not significantly and adversely affect the organoleptic or stability properties of the filling. Such optional ingredients include, for example, flavorings (e.g., salt, cheese flavors, meat flavors, vegetable flavors, fruit flavors, and the like), spices, herbs, colorants, nutritional supplements (e.g., vitamins, minerals, probiotics, botanicals, and the like). The filling may also include preservatives. It is particularly preferred that the filling comprises antioxidants such as, for example, butylated hydroxyanisole (BHA), butylated hdyroxytoluene (BHT), tert-butylhydroquinone (TBHQ), rosemary extract, green tea extract, tocopherol, and combinations thereof. Generally, the amount of antioxidant is less than about 0.2 percent but higher amounts of antioxidant may be used if desired. In one aspect, the antioxidant is provided in an amount of less than about 0.1 percent based on the weight of the filling. The amount of antioxidant selected for use in the filling should be an amount effective to provide a shelf-stable product at ambient temperatures for at least about four months. Other compounds which are effective preservatives for oils and fats may also be used if desired. Other preservatives routinely used in the food industry may also be used, such as, for example, salt, nitrates, nitrites, citric acid, sodium erythorbate, and the like. The amount of preservative should be selected so as to effective as a preservative but which generally does not cause off flavors or colors to the filling.

To the extent that the bulking agent may include ingredients which contribute sweetness to the filling, additional sweeteners may be included in the filling, such as sucrose, fructose, glucose, other sweet mono- or disaccharides, artificial sweeteners, non-nutritive sweeteners, high intensity sweeteners, sugar alcohols, and the like, if desired. The filling also may contain minor amounts of other functional and flavoring additives commonly used in savory products, such as salt, herbs, seasonings, spices, and the like, if desired. The filling may also be fortified with macronutrients and/or micronutrients, such as iron preparations, bioavailable calcium sources, vitamins, minerals, amino acids, and other nutraceuticals.

The filling ingredients may be combined all at once or in separate stages. The particular order of addition of the ingredients is not critical and may depend on the particular equipment available. The filling has a moisture content of about 0 to about 20, preferably about 0 to 10, and more preferably 0 to about 5. The filling has a water activity of less than about 0.5 and is shelf-stable for at least about 4 months at ambient temperatures. In another aspect, the filling has a water activity of less than about 0.50, more preferably less about 0.4 and a shelf life of at least about 6 months at ambient temperature.

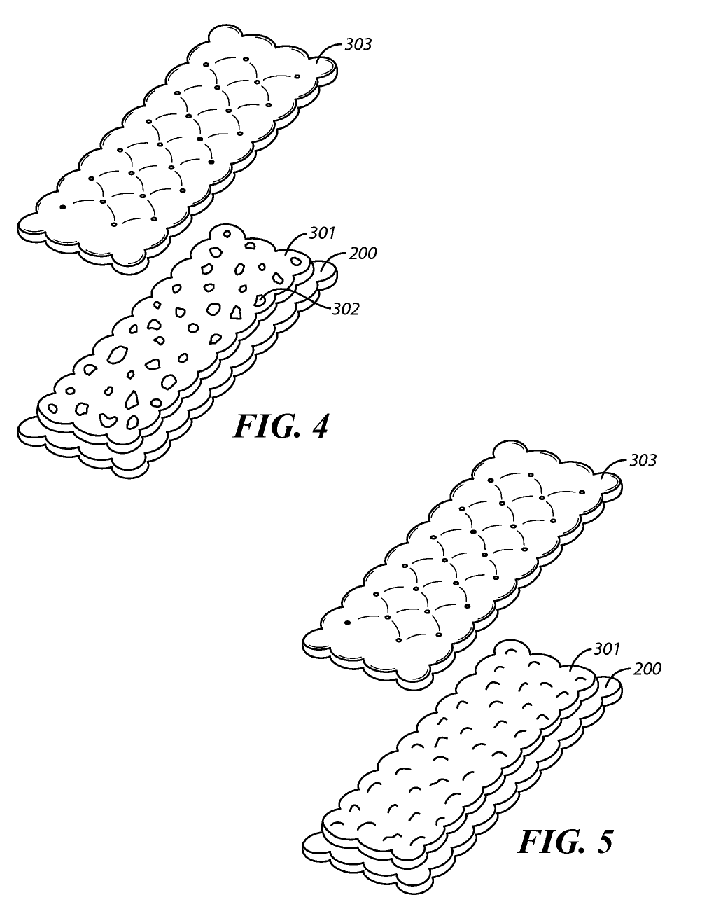

In another aspect, and as shown in FIG. 4, a filling 301 comprises a particulate component 302, preferably a particulate meat component, dispersed in the fat component of filling 301 as described above and as provided in Table 2. In one aspect, the filling 301 comprises about 0 to about 20 percent particulate component by weight of the filling. In another aspect, the filling 301 comprises about 0.5 to about 15 percent particulate component. In yet another aspect, the filling 301 comprises about 1 about 10 percent particulate component. In yet another aspect, the filling 301 comprises about 3 to about 7 percent particulate component. The particulate component should be generally uniformly dispersed in the filling to provide a more uniform taste experience to the consumer.

In one aspect, the amount of particulate meat component is less than about 2 percent of the total weight of the cracker-and-filling sandwich, although other amounts of particulate meat component can be used if desired.

The particulate component used herein can comprise, by one approach, meat particles. The particulate component useful herein can be regularly or irregularly shaped particles. Irregularly shaped particles are depicted in FIG. 4, but the actual shape of the particles does not appear to be especially important. There is also no particular requirement that the particles be similar in shape to one another. However, the particles should be of a size and shape effective to be substantially covered by the fat component and of a size and quantity effective to provide the desired amount of particles in the filling. The size and quantity of particles is also selected to provide the desired amount of flavor to the filling.

While meat particles having low water activity are less susceptible to oxidative rancidity, the risk of oxidative rancidity is reduced, and the shelf-life extended, by substantially covering the particulate meat component by the fat component. By “substantially cover” or similar language, it is meant that the surface area of the individual particles making up the particulate component are at least 50 percent covered by the fat component, preferably at least about 70 percent covered by the fat component, and more preferably at least about 80 percent covered by the fat component. The thickness of the covering layer of fat component does not have to be uniform. In yet another aspect, and as depicted in FIG. 5, the particulate component is encapsulated by the fat component in the filling 301 such that no individual particles are visible which are not covered with fat component. “Encapsulate” or similar language means the fat component of the filling 301 covers essentially the entire surface of the particles. It is particularly preferred that the surface area of the individual particles making up the particulate component are at least covered or encapsulated by, as described above, a mixture of fat component and antioxidant to increase the shelf-stability of the product.

In one aspect, the particulate meat component has a mean particle size of about 0.05 mm to about 15 mm. In another aspect, the particulate meat component has a mean particle size of about 0.1 mm to about 10 mm. In another aspect, the particulate meat component has a mean particle size of about 0.1 mm to about 3 mm. In another aspect, the particulate meat component has a mean particle size of about 0.5 mm to about 2.5 mm. In another aspect, the particulate meat component has a mean particle size of about 1.0 mm to about 2.0 mm. The particle sizes described herein are measured using a longest linear dimension from one side to the opposing side, which allows for the determination of particle sizes for both regularly and irregularly shaped particles.

Depending on the size and shape of the particles, the particulate component can provide texture to the filling which is organoleptically pleasing to the consumer. A small particle size (such as the particle size ranges described above) provides more surface area for exposure of any natural fats present within the particulate component. These exposed fats are believed to be stabilized by preservatives, preferably antioxidants, present in the fat component via fat migration from the fat component into the particulate component. Also, small particles are more easily substantially covered with the fat component during mixing. The fat component reduces the exposure of the natural fats in the particulate component to oxygen, such that the oxygen transmission rate to the particulate component is reduced by about 25 to about 50 percent. Such combination of the fat component with the particulate component provides a substantially longer shelf life of the filling than if the fat component was not used. A combination of fat component, antioxidant, and particulate component provides for even longer shelf life of the filling than when the antioxidant is not included. For example, a particulate meat component without a coating with a mixture of fat component and antioxidant would be expected to have a shelf life of less than a month, more likely less than two weeks, whereas combining the particulate component with the fat component and antioxidant as described provides a shelf life of at least about four months.

The exposure of the particulate component to oxygen is also reduced when second cracker 303 is placed on the filling 301 to form the cracker-and-filling sandwich, the second cracker 303 thus forming a second barrier to oxygen transmission.

In an alternative aspect, the meat can be provided in a larger size, such as in the form of strips, chunks, bits, slices, slabs, cubes, and the like. The meat should be provided in a size that can be substantially covered by the fat component of the filling. Accordingly, the meat should not be larger than the crackers that the meat and filling are positioned between. As used herein, “substantially cover” means that the surface area of the meat is at least 50 percent covered by the fat component, preferably at least about 70 percent covered by the fat component, and more preferably at least about 80 percent covered by the fat component. The thickness of the covering layer of fat component does not have to be uniform. In one aspect, the meat component is encapsulated by the fat component in the filling such that the surface of the meat is not visible. “Encapsulate” or similar language means the fat component of the filling covers essentially the entire surface of the meat. It is particularly preferred that the surfaces of the meat are at least covered or encapsulated by, as described above, a mixture of fat component and antioxidant to increase the shelf-stability of the product.

The meat component can be prepared from a variety of types of meat. For example, the particulate component can be prepared from bacon, pepperoni, ham, turkey, sausage, chicken, beef, pork, and the like.

As is well known, meat products are prone to oxidative rancidity. To provide shelf-stability, the meat should have low water activity (i.e., a water activity of less than about 0.6). Low water activity also provides the necessary dryness for grinding the meat to the desired particle size. Meat having an A_{w} of less than 0.6, such as about 0.2 to about 0.6 in one aspect, about 0.40 to about 0.55 in another aspect, are particularly suitable for use herein to assist in retarding oxidative rancidity. Meat having an A_{w} of less than about 0.2 may be used, such as freeze dried meat products, but these meats tend to have increased rates of oxidative rancidity. These meats can be used if more rigorous packaging methods are used, including vacuum packing with nitrogen in packages which allow for little to no oxygen transmission.

In general, the fat content of the meat also contributes to the shelf life of the meat product. For example, using lean meats (e.g., meats having a fat content less than about 10 percent) will also tend to extend the shelf life of the meat. Meats having a fat content of about 5 to about 40 can be used herein, with meats having a fat content less than about 25 weight percent are generally preferred from a shelf stability standpoint, with a fat content of less than about 20 percent being particularly preferred. However, meats having a fat content greater than 25 percent may also be used, if desired, so long as the level of fat in the meat does not adversely affect the shelf stability of the product.

The meat may also include additives such as preservatives, flavors, colorants, or the like, if desired, so long as the additives do not affect the organoleptic or stability properties of the filling.

Alternatively, or in addition to, the particulate component may be prepared from meat analog products instead of meat. Exemplary meat analog products include, but are not limited to, those made from soy, legumes, rice, wheat gluten, textured vegetable protein, and the like. Meat analog products having a water activity of less than about 0.6, preferably about 0.4 to about 0.55, are particularly useful.

In one aspect, the filling can be combined with the particulate component prior to placing the filling on a cracker. In this aspect, the particulate component is provided in the desired particle size (or sizes) and incorporated into the filler (i.e., combined with the fat component). The particulate component can be added before, during, or after the process for making the filling. The filling containing the particulate component can then be deposited onto a cracker as described in greater detail below.

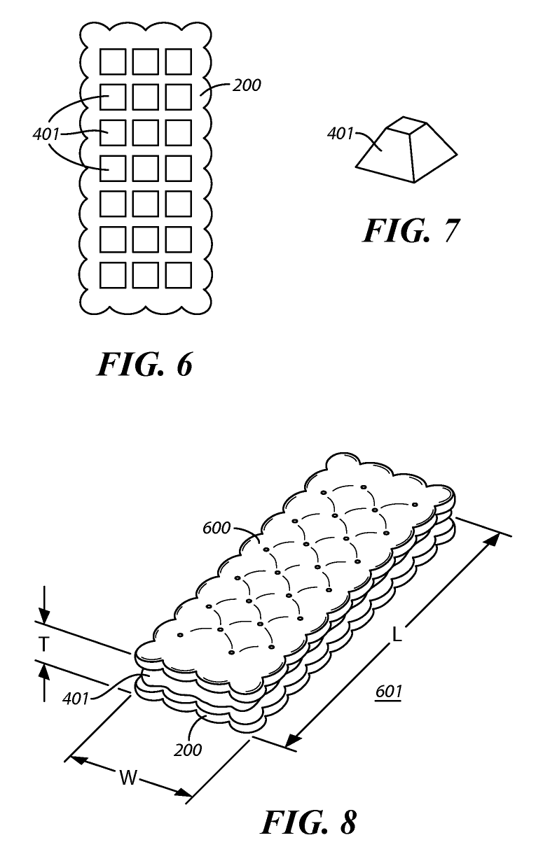

Referring momentarily to FIGS. 6 and 7, the filling 401 can be placed atop the first cracker 200 as a plurality of individual dollops. Each such dollop can have a wider base (where the filling 401 contacts the first cracker 200) than top or peak. As illustrated in FIG. 7, each such dollop comprises a kind of truncated pyramid. Those skilled in the art will recognize and understand that any number of other shapes are possible. It will also be understood that these teachings do not require that each dollop be identical to the other dollops in size, shape, footprint, height, or the like.

Generally speaking, the height of the dollops is somewhat higher than the expected thickness of this filling layer in the finally-constructed filling-and-cracker sandwich. As will be shown below, this will permit the filling 401 to be somewhat compressed in a latter step. With this in mind, the filling 401 can be sufficiently viscous that the resultant food product can be hand compressed by at least ten percent without coincidentally also breaking either of the crackers that form the sandwich.

By one approach, these dollops can be disposed on the first cracker 200 using three extrusion nozzles that are oriented laterally across the first cracker 200. As the first cracker 200 and these extrusion nozzles move with respect to one another, one row of dollops after another can be placed in seriatim manner. The amount of space left between such dollops (or whether there is any such space at all) will vary depending upon the needs and/or opportunities as tend to characterize a given application setting.

Those skilled in the art will recognize that each such dollop can be comprised of the same filling material. These teachings will also accommodate, however, other possibilities in these regards. For example, the outer dollops can be comprised of a filling that is based upon a first kind of cheese while the inner dollops are comprised of a filling that is based upon a second, different kind of cheese. As another example, one set of dollops can contain one kind of meat component while another set of dollops contain a different kind of meat component. As yet another example in these regards, one set of dollops can comprise a meatless filling while another set of dollops comprises a meat-containing filling. Other possibilities in these same regards are possible.

The filling can be applied to the cracker using numerous other conventional techniques, if desired. The above discussed method is merely an exemplary method of placing the filling on the cracker. For example, the filling can be placed on the cracker in one strip or one dollop or a plurality of strips or dollops.

Referring again to FIG. 1, at step 103 this process 100 next provides for placing a second cracker on the aforementioned filling 401 to thereby form a filling-and-cracker sandwich. Such a resultant filling-and-cracker sandwich 601 appears in FIG. 8. In this illustrative example, this second cracker 600 is essentially identical to the first cracker 200. Those skilled in the art will recognize that this second cracker 600 could, however, be different from the first cracker 200 in any of a variety of ways. For example, this second cracker 600 could be formed of one or more different ingredients, a different mixture of the same ingredients, and/or could be formed to have a different shape or the like as desired.

In this illustrative example, where the second cracker 600 is essentially identical to the first cracker 200, the second cracker 600 is positioned to be in substantial vertical registration with the first cracker 200. Accordingly, the four corners of both crackers are in general vertical alignment with one another.

When so placing this second cracker 600 to form the filling-and-cracker sandwich 601, the second cracker 600 is urged downwardly with sufficient force to fully engage the filling 401 and to cause some corresponding compression of the filling 401. This compression can be sufficient to cause the filling 401 to fill the aforementioned spaces between the filling dollops and to also flow outwardly towards the periphery of the crackers. By one approach, there is neither so much filling 401, nor so much compression, as to cause the filling 401 to extend greatly beyond the periphery of the crackers for a substantial extent of that periphery.

In actual testing, when the filling 401 was compressed 3 mm at a rate of 1 mm/second, the filling flowed (which might be viewed by some skilled in the art as a kind of deformation) between the crackers in response to this relatively low pressure. More particularly, the corresponding pressure ranged from about 0.1 kg/square centimeter to about 0.3 kg/square centimeter (assuming the full cracker surface served as a contact area with the filling). Assuming that, in fact, only about seventy percent of the cracker surface served as a contact area, the relevant pressure range would be, instead, from about 0.15 kg/square centimeter to about 0.4 kg/square centimeter. (The differences between the low end and the high end of this range were generally attributable to different cheese powders that were used in different samples, with a cheddar cheese powder representing the low end of this range and a garlic herb cheese powder yielding the high end of this range.)

In another aspect, the filling 401 placed atop the first cracker 200 can be applied to the cracker prior to combining the filling 401 with the particulate component. In this aspect, the particulate component could be sprinkled onto the top of the filling prior to capping with a second cracker. Capping with the second cracker should provide sufficient pressure to the particulate component to embed the particulate component in the filling such that the surface area of the individual particles making up the particulate component is at least 50 percent covered by the filling.

In this particular illustrative example, the length-to-width ratio (L/W) of the cracker can be at least 2:1 and is, as shown in excess of 2.5:1. Accordingly, the filling-and-cracker sandwich 601 is considerably longer than it is wide. Also in this example, the thickness of each cracker is about 0.2 inches as is the resultant thickness of the filling 401 layer. This yields a resultant thickness of about 0.6 inches for the filling-and-cracker sandwich 601. The dimensions described herein are merely exemplary. Other dimensions can also be used to provide a desired shape and thickness depending on the particular desires of consumers, such as the desired strength of the crackers or the desired amount of filling per cracker sandwich.

In consumer testing, such a filling-and-cracker sandwich 601 as described above scored surprisingly high in numerous positive regards. For example, against a broad field of competing snack items such a filling-and-cracker sandwich 601 easily received a highest percentage of praise from the responding testers and little in the way of criticism. Although taste, mouthfeel, and the like no doubt play a part in such a favorable reception, it is the filling-and-cracker sandwich's satiety that may have also played a large part in garnering such a strong and broad-based favorable reaction.

In particular, in one blind monadic home-use test involving a filling-and-cracker sandwich as described herein but without a particulate in the filling (involving hundreds of adult testers, both male and female in approximately equal numbers and with ages that reflect census age proportions and who all present themselves as typically snacking between meals), 88% agreed “completely or somewhat” with the statement “this product satisfies your hunger until your next meal.” More particularly, 51% of the test group agreed completely with that statement while only 6% disagreed somewhat or completely.

This measured effectiveness in sating between-meals appetite is even more surprising when one considers that the filling-and-cracker sandwiches being tested only offered between about 130 and 140 calories. At only 4.6 calories per gram, the confirmed satiety of the filling-and-cracker sandwich for such a large group of relevant testers constitutes a surprising result. As a potentially related observation, the filling-and-cracker sandwich used in these tests employed a cheese-based filing that included more fiber than the crackers themselves. More particularly, the filling comprised about 30% cheese powder with the remainder comprising fat, some solidification ingredients, and fiber (with about 3 grams of fiber being used for the filling in each filling-and-cracker sandwich). Fiber, of course, contributes to a good mouthfeel and lubricity, but may also have contributed to the unusual satiety of the tested filling-and-cracker sandwich.

In one aspect the filling-and-cracker sandwich comprising particulate meat component also provides between about 130-140 calories and provides satiety similar to or greater than that of the filling-and-cracker sandwich not including the particulate meat component.

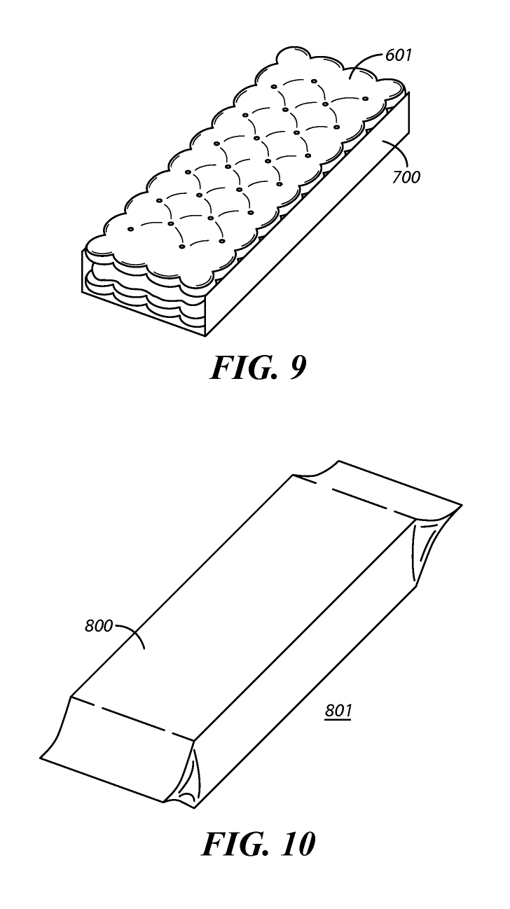

Given such telling results, and referring again to FIG. 1, these teachings will further optionally accommodate a step 104 of wrapping the filling-and-cracker sandwiches in individual wrappers as befits their clear status as single-serving snack items. By one approach, and referring now to FIG. 9, each filling-and-cracker sandwich 601 can be placed on a paperboard tray 700. If desired, and as illustrated, this paperboard tray 700 can have both a bottom and two sides to thereby provide considerable protection to the filling-and-cracker sandwich 601 from laterally and vertically-imposed forces.

Referring now to FIG. 10, the filling-and-cracker sandwich (with or without the aforementioned paperboard tray or other tray, container, or the like) can be placed within a wrapper 800 comprised of flexible material to thereby yield a corresponding single-serve package 801. Those skilled in the art will recognize that there are various known ways to wrap such a food product. By one approach, and as illustrated, the wrapper 800 can be applied using a flow-wrapper process as is well known in the art. Such a wrapper 800 will seal the filling-and-cracker sandwich away from local atmospheric influences and aid in preserving the freshness of the filling-and-cracker sandwich.

The wrapper can be formed of polymeric material, such as polymeric materials known in the art for use in flow-wrapper processes. Exemplary materials in clued polyethylene/EVA with a VA content of between about 4 to 22 percent, polybutylene, Surlyn, Bynel, Saran (PVDC) copolymer, ethylene acrylic acid copolymer, or methacrylic acid copolymer. As disclosed in, e.g., U.S. Pat. No. 4,782,951, the disclosure of which is incorporated herein by reference, a hermetic peelable seal may be formed between a Saran copolymer lamina and an EVA lamina.

The wrapper is preferably made of a suitable laminated material having barrier properties which, when sealed as described herein, provide hermeticity. For purposes of example, a suitable film may comprise a linear low-density polyethylene inner layer in combination with a polyester or nylon outer layer, and a middle adhesive layer of polyethylene.

By one approach, if desired, the filling 401 can have an adhesive characteristic that is sufficient to retain the first and second crackers 200 and 600 in place during pre-sale handling, distribution, and sale of the food product. This adhesive characteristic can be sufficient to comprise a crumb-retention medium to thereby prevent most cracker crumbs from falling away from the filling-and-cracker sandwich 601 during consumption by an end user. The latter characteristic in particular befits the snacking-nature of the filling-and-cracker sandwich 601. In particular, the person consuming the filling-and-cracker sandwich 601 is likely eating the food product without the benefit of a plate or possibly even an official eating surface such as a dining table. Given this expected application setting, a reduction in resultant falling food-particle debris is most welcome by many consumers.

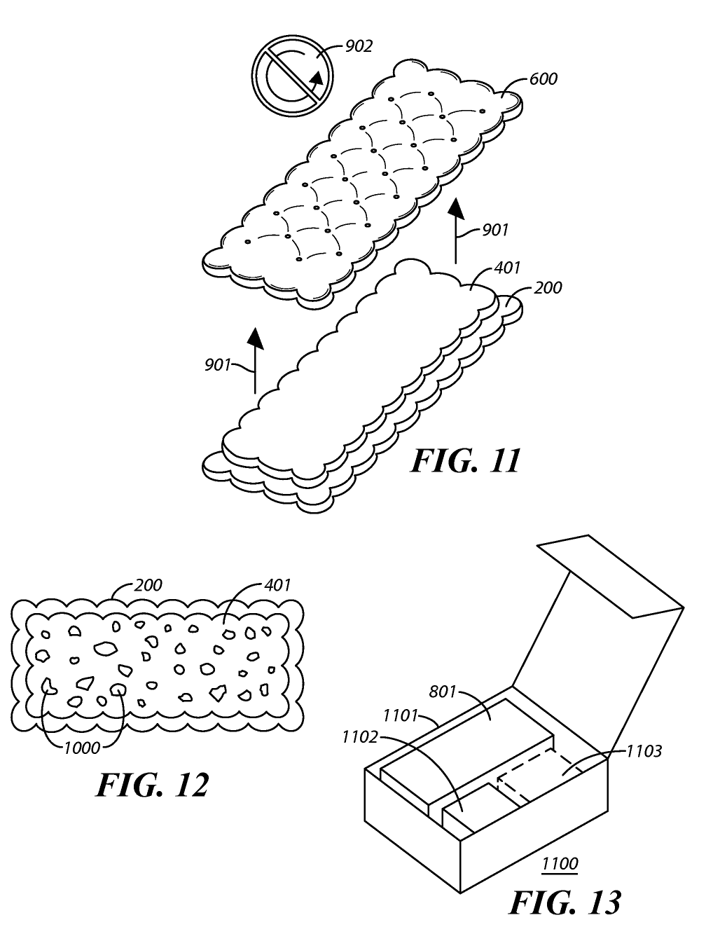

At the same time, however, this adhesive characteristic is not sufficient to prevent an end user from easily removing the second cracker 600 from the filling-and-cracker sandwich 601 using only their hands (presuming this end user to be an average able-bodied adult human with at least average dexterity and motor skills). As suggested by the illustration presented in FIG. 11, this removal of the second cracker 600 should be achievable without breaking either of the crackers 200 and 600. In testing, for example, only one cracker in thirty exhibited breakage when removing the second cracker 600 in this manner. Furthermore, this removal of the second cracker 600 should be achievable in this illustrative example by simply lifting the second cracker 600 away as indicated by the arrows denoted by reference numeral 901 and without requiring that the cracker being removed be rotated with respect to the filling (as represented by the icon denoted by reference numeral 902).

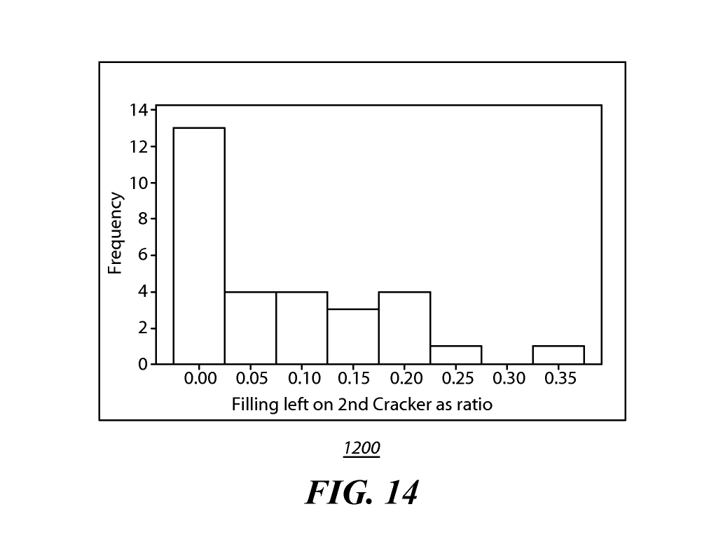

These teachings will accommodate some of the filling 401 becoming separated as well, such that a portion of the filling remains on the removed second cracker 600. Generally speaking, however, this separated portion will typically remain relatively small. For example, in many cases, less than 10% (or even less than 5%) of the total filling 401 will become separated and remain with the removed cracker. FIG. 14 presents a histogram 1200 depicting actual test results in these regards. In these tests, meatless filling-and-cracker sandwiches as described herein had the top cracker removed by lifting that top cracker without rotation. The weight of the filling remaining on that removed cracker was then compared against the total weight of the filling to determine the ratio of the removed filling to the original amount. For example, in this histogram 1200, one can see that thirteen sandwiches exhibited the removal of virtually no filling while four sandwiches exhibited the removal of only around 5% of the filling. Only in two cases (out of thirty) did 25% or more of the filling become separated.

It is believed that such a result can be achieved, at least in part, by the previously described approach of first disposing the filling 401 on the first cracker 200. Using this approach, a greater portion of the filling 401 will be in intimate adhesive contact with the first cracker 200 than with the second cracker 600. For example, by one approach, there may be twice as much filling surface area in intimate contact with the first cracker 200 than with the second cracker 600 as the first cracker 200 is in substantially greater surface-area contact with the filling 401 than the second cracker 600.

In any event, this ability to easily remove the top cracker from the filling-and-cracker sandwich offers other opportunities to leverage this food product design. As one illustrative example, and referring now to FIG. 12, after removing such a filling-and-cracker sandwich from its wrapper, and after removing one of the crackers as described, one can dispose at least one supplemental food item 1000 on the filling 401. The removed cracker can then be replaced in substantially unbroken form to thereby form a nutritionally-supplemented filling-and-cracker sandwich. Those skilled in the art will recognize that any number of supplemental food items will serve in these regards including, but not limited to, bacon bits, pepperoni slices or bits, flavored sauces, and so forth.

Referring now to FIG. 13, such a capability can be exploited by offering an individually wrapped filling-and-cracker sandwich 801 in a package 1101 that also includes such a supplemental food item 1102. Such a meal kit 1100 can optionally include one or more other items 1103 as desired (such as additional supplemental food items to add to the filling-and-cracker sandwich, side items to be individually consumed apart from the filling-and-cracker sandwich but during the same dining opportunity, utensils, and so forth).

The filing-and-cracker sandwich may be gas flushed with carbon dioxide or nitrogen during packaging to extend the shelf life of the product.

For the sake of further explanation, but with no intention of suggesting any limitations in these regards, two specific salient examples regarding specific recipes for crackers and cheese-based fillings suitable for use in accord with these teachings will now be presented. Unless otherwise noted in this disclosure, all percentages, ratios, and the like are based on weight.

### Example 1:

To form the crackers, the oil, lecithin, high fructose corn syrup, sugar, butter flavoring, water, and flour are mixed for 4 to 8 minutes in an upright mixer according to the following dough formulation:

| Ingredient | Amounts | |
|---|---|---|
| Low trans oil | 4.1 | kg |
| Lecithin | 0.08 | kg |
| High fructose corn syrup | 0.7 | kg |
| Sugar | 5.4 | kg |
| Butter flavoring | 0.027 | kg |
| Water | 12.9 | kg |
| Flour | 25.8 | kg |
| Ammonium bicarbonate | 0.45 | kg |
| Enzymes | 8.1 | grams |
| Graham flour | 19.5 | kg |
| Sodium bicarbonate | 0.48 | kg |
| Calcium phosphate monobasic | 0.51 | kg |
| Dough salt | 0.17 | kg |

The remaining ingredients are then added and the mixing continued for another 6 minutes. The dough is proofed (rested) (for about 90 minutes to about 150 minutes), sheeted, and laminated. The dough is then baked for about 5 minutes at 250 to 550° F.

Following the baking process, it is preferable, but not required, to apply oil to one or both sides of the crackers to provide additional moisture, color, and savory flavor to the cracker.

While the above recipe includes a two-step mixing process, a one-step mixing process may be used as long as the ingredients are well mixed prior to resting the dough. Also, if desired, the flour ingredients can be added other than as suggested above as regards the two-step mixing process.

The following ingredients are then added and the mixing continued for another 4 to 10 minutes:

### Example 2:

To form a filling, the following ingredients are mixed for about 1 to 2 minutes in a high shear mixer according to the following formulation:

| Ingredient | Amounts |
|---|---|
| Shortening | 63.5 kg |
| Canola oil | 45.3 kg |

The following ingredients are then added and mixing continues for another 6 to 15 minutes:

| Ingredient | Amounts | |
|---|---|---|
| Resistant maltodextrin | 56.2 | kg |
| Maltodextrin | 23.1 | kg |
| Corn syrup solids | 23.1 | kg |
| Cheese powders | 90.7 | kg |
| Flavors | 2.6 | kg |

Again, while the above recipe includes a two-step mixing process, a one-step mixing process may be used as long as the ingredients are mixed to provide a substantially homogeneous mixture. It would also be possible to introduce some of these ingredients in a step other than the one shown.

A particulate component, such as a particulate meat component, can be added before, during, or after the process for making the filling as described above.

These teachings yield a single-serving-sized filling-and-cracker sandwich that is remarkably successful at sating between-meals appetites when used as a snack food. Its form factor and single-serving-sized packaging is both suggestive of this purpose and also effective to suggest to the consumer that consuming further such filling-and-cracker sandwiches is unnecessary. Furthermore, such a filling-and-cracker sandwich is readily leveragable as a key component in a meal kit as the filling-and-cracker sandwich is easily opened in order to permit an end user to supplement the filling-and-cracker sandwich with additional ingredients.

### Example 3:

A filling was prepared with meat particulates according to the following steps. The ingredients in the table below were mixed to provide a bacon flavored filling containing small bacon pieces:

| Ingredient | Amounts |
|---|---|
| Non-Hydrogenated Shortening | 19.8% |
| High Oleic Canola oil | 14.1% |
| Lactic acid 88% | 0.14% |
| Natural cheddar cheese flavor | 0.14% |
| Lecithin | 0.016% |
| Rosemary extract WS 1500 | 0.094% |
| Resistant maltodextrin | 18.3% |
| Dry maltodextrin, 9-13D | 6.32% |
| Corn syrup solids | 7.16% |
| Cheese powders (4.7% Cheeztang NCS, 7.04% | 28.2% |
| Chedasharp 501 Uncolored, 16.43% Sequoia 2 | |
| Uncolored) | |
| Smoky Bacon flavor | 0.85% |
| Bacon bits low moisture fines | 4.88% |

The bacon bits used had a maximum fat content of 18.58% and a maximum A_{w} of 0.55. The bacon bits had a maximum particle size of about 2.45 mm.

The filling was then used to prepare a cracker sandwich using two crackers. The filling was dispensed on a first cracker using extrusion nozzles oriented laterally across the first cracker. A second cracker is then placed on the filling on the first cracker to provide a filling-and-cracker sandwich.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A shelf-stable savory filling comprising:
fat component;
antioxidant; and
particulate meat component having a water activity of about 0.4 to about 0.55, the particulate meat component dispersed in the fat component and antioxidant.

2. The shelf-stable savory filling of claim 1, wherein the filling has a water activity of less than about 0.5.

3. The shelf-stable savory filling of claim 1, wherein the particulate meat component has a fat content of about 5 to about 40 weight percent based on the weight of the particulate meat component.

4. The shelf-stable savory filling of claim 1, wherein the filling includes about 0.5 to about 15 percent particulate meat component.

5. The shelf-stable savory filling of claim 1, wherein the particulate meat component is substantially uniformly dispersed in the fat component.

6. The shelf-stable savory filling of claim 1, wherein the particulate meat component comprises a meat product selected from the group consisting of bacon, pepperoni, ham, turkey, sausage, chicken, beef, pork, and combinations thereof.

7. The shelf-stable savory filling of claim 1, wherein the particulate meat component has a mean particle size of about 0.1 mm to about 10 mm.

8. The shelf-stable savory filling of claim 1, wherein the particulate meat component has a mean particle size of about 0.5 mm to about 2.5 mm.

9. The shelf-stable savory filling of claim 1, wherein the filling comprises about 25 to about 50 percent fat component.

10. The shelf-stable savory filling of claim 1, wherein the filling comprises about 30 to about 40 percent fat component.

11. The shelf-stable savory filling of claim 10, wherein the fat component comprises a vegetable oil selected from the group consisting of palm, soybean, canola, cottonseed, sunflower, or mixtures thereof.

12. The shelf-stable savory filling of claim 1, wherein the particulate meat component comprises a plurality of individual meat particles each having a surface area and the fat component covers at least 50 percent of the surface area of the individual meat particles.

13. A method for preparing a shelf-stable savory filling, the method comprising:
mixing a fat component, antioxidant, and particulate meat component to provide the shelf-stable savory filling.

14. The method of claim 13, wherein the filling has a water activity of less than about 0.5.

15. The method of claim 13, wherein the filling includes about 0.5 to about 15 percent particulate meat component.

16. The method of claim 13, wherein the particulate meat component has a mean particle size of about 0.5 to about 2.5 mm.

17. The method of claim 13, wherein the filling comprises about 25 to about 50 percent fat component.

18. The method of claim 13, wherein the meat particles have a surface area and the mixing is effective to cover at least 50 percent of the surface area of the meat particles with the fat component.

19. A shelf-stable food product comprising:
a first cracker,
a second cracker, and
a filling disposed between the first and second crackers, the filling comprising:
fat component;
antioxidant; and
particulate meat component dispersed in the fat component and antioxidant.

20. The food product of claim 19, wherein the filling comprises about 1 to about 10 percent particulate meat component.

21. The food product of claim 19, wherein the particulate meat component has a fat content of about 5 to about 40 percent by weight of the particulate meat component.

22. The food product of claim 19, wherein the filling comprises about 25 to about 50 percent fat component.

23. The food product of claim 19, wherein the particulate meat component has a water activity of less than about 0.6.

24. The food product of claim 19, wherein the particulate meat component comprises a plurality of individual meat particles each having a surface area, and the fat component of the filling covering at least 50 percent of the surface area of the individual meat particles.

25. The food product of claim 19, wherein the filling has a fiber content and the first and second crackers have a combined fiber content, wherein the fiber content of the filling is higher than the combined fiber content of the first and second crackers.

26. A method for retarding the oxidative rancidity of meat in a shelf stable food product, the method comprising:
providing a filling comprising a fat component and antioxidant; and
disposing a meat product in the filling such that the meat product is substantially covered by the filling.

27. The method of claim 26, wherein the meat product is a particulate having a mean particle size of about 0.1 to about 10 mm.

28. The method of claim 26, wherein the meat product has a fat content of less than about 20 percent based on the weight of the meat.

29. The method of claim 26, wherein the filling covers at least about 70 percent of the meat's surface.

30. The method of claim 26, wherein the meat product is provided in the form selected from the group consisting of slab, cube, strip, slice, chunk, bit, and combinations thereof.

31. A method for preparing a shelf stable cracker and meat food product, the method comprising:
providing a filling comprising a fat component and antioxidant;
disposing a meat product in the filling such that the meat product is substantially covered by the filling to provide a meat filling;
dispensing a quantity of meat filling on a first cracker; and
placing a second cracker on the meat filling on the first cracker to provide a cracker sandwich.

32. The method of claim 31, wherein the meat product is a particulate meat product having a mean particle size of about 0.1 to about 10 mm.

33. The method of claim 31, wherein the meat product has a fat content of less than about 20 percent based on the weight of the meat.

34. The method of claim 31, wherein the filling covers at least about 70 percent of the meat's surface.

35. The method of claim 31, wherein the meat product is provided in the form selected from the group consisting of slab, cube, strip, slice, chunk, bit, and combinations thereof.
